(19) United States
(12) Patent Application Publication
(10) Pub. No.: US 2023/0006592 A1
(43) Pub. Date: Jan. 5, 2023

(54) CONTINUOUSLY VARIABLE SPEED CONTROLLER, ELECTRIC LIFT MECHANISM, AND ELECTRIC MASSAGING MECHANISM

(71) Applicant: ZHEJIANG JIECANG LINEAR MOTION TECHNOLOGY CO., LTD., Zhejiang (CN)

(72) Inventors: Xueli CHEN, Zhejiang (CN); Zhekang ZHANG, Zhejiang (CN); Senyu CHEN, Zhejiang (CN); Shaoping ZHOU, Zhejiang (CN)

(73) Assignee: ZHEJIANG JIECANG LINEAR MOTION TECHNOLOGY CO., LTD., Zhejiang (CN)

(21) Appl. No.: 17/366,013

(22) Filed: Jul. 1, 2021

(51) Int. Cl. H02P 23/20; H02P 23/14; B66F 7/12; A61H 23/02

(52) U.S. Cl. CPC H02P 23/20; H02P 23/14; B66F 7/12; A61H 23/02; A61H 2201/1463; A61H 2201/5007; A61H 2201/5071; A61H 2201/5023; A61H 2201/5069

(57) ABSTRACT

A continuously variable speed controller comprises an operating unit, an operation detector coupled to the operating unit to detect a continuous variation of an action of the operating unit, an information processor electrically connected to the operation detector to obtain a corresponding motor speed variation quantity based on a detection result from the operation detector, and a motor controller electrically connected to the information processor to receive the motor speed variation quantity and adjust a speed of the motor continuously based on the motor speed variation quantity. As such, speed control becomes more intuitive, and can achieve stepless speed change, while no need to set the speed switch to occupy the control and detection ports, simplifying structure of the product.

### FIELD OF THE INVENTION

Embodiments of the present disclosure generally relate to continuously variable speed controller technologies, and more particularly relate to continuously variable speed controller, electric lift mechanisms, and electric massaging mechanisms.

### BACKGROUND OF THE INVENTION

Electric lift mechanisms such as electric lift tables, electric tatamis, electric sofas, and electric beds enable height adjustment to meet requirements of users and thus are comfortable in use, which is why they are increasingly applied in scenes such as offices, schools, home, and hospitals.

Electric platforms of existing electric lift mechanisms can only be lowered and raised at a fixed speed, the operating modes of which include: long-press lift, press lift, and one-touch auto-lift, etc. As platforms are applied in an increasingly wide array, different application scenarios have different speed requirements; and with constant advancement of technologies and processes, the lift speed of electric platforms increases from initially 10-40 mm/s to above 100 mm/s. In the context of the currently high speed or in a scenario of requiring a fast lift, a variable-speed lift operation enables one to accommodate a high acceleration upon actuation by speed control before the electric platform reaches the maximum speed. The variable-speed lift operation resembles a continuous speed variation and improves lift performance, realizing maximum exploitation of the performance.

Existing speed control technologies available in the market mostly perform speed control by a gear selector switch, a multi-gear toggle switch, or by defining different pushbuttons or different operations to correspond to different speeds, which, however, are not intuitive to operate. Besides, only limited gear positions can be arranged, which limits speed variation. Further, more control and detection ports are needed to match the gear positions, rendering a complex product structure.

### SUMMARY OF THE INVENTION

Embodiments of the present disclosure provide continuously variable speed controllers, electric lift mechanisms, and electric massaging mechanisms, which achieve a continuous speed variation and a simplified product structure.

Embodiments of the present disclosure provide the following technical solution: a continuously variable speed controller comprising an operating unit, an operation detector coupled to the operating unit to detect a continuous variation of an action of the operating unit, an information processor electrically connected to the operation detector to obtain a corresponding motor speed variation quantity based on a detection result from the operation detector, and a motor controller electrically connected to the information processor to receive the motor speed variation quantity and adjust a speed of the motor continuously based on the motor speed variation quantity.

In an embodiment, the operating unit comprises a first shell and a paddle provided on the first shell; the operation detector comprises at least one of a pressure sensor provided in a stressed zone of the paddle and an angle sensor provided on a follow-up surface of the paddle.

In an embodiment, the pressure sensor comprises a piezoelectric transducer, a piezoresistive transducer, or a conductive elastic member, wherein deformation of the conductive elastic member results in a change to resistive value.

In an embodiment, the information processor and the motor controller are integrated onto a first signal processing board, the first signal processing board being provided in the first shell and electrically connected to the pressure sensor.

In an embodiment, the operating unit comprises a second shell and a first rotating housing provided on the second shell; the operation detector comprises a magnetically inductive sensor and a magnet, wherein the magnetically inductive sensor is provided on the first rotating housing and rotatable with the first rotating housing, and the magnet is fixed in the second shell.

In an embodiment, the operating unit comprises a second shell and a first rotating housing provided on the second shell; the operation detector comprises a magnetically inductive sensor and a magnet, wherein the magnetically inductive sensor is fixed in the second shell, and the magnet is fixed on the first rotating housing and rotatable with the first rotating housing.

In an embodiment, the operating unit comprises a third shell and a second rotating housing provided on the third shell, and the operation detector comprises a rotating encoder fixed in the third shell or an angle sensor fixed on the second rotating housing.

In an embodiment, the operating unit comprises a fourth shell and a pushbutton provided on the fourth shell. The operation detector comprises a circuit board provided in the fourth shell; and a conductive elastic member provided between the pushbutton and the circuit board, and configured to be deformed by pressing the pushbutton.

In an embodiment, the operating unit comprises an air chamber, the space in the air chamber space being compressible by pressing the air chamber; and the operation detector comprises an air pressure sensor that is provided in the air chamber.

Embodiments of the present disclosure further provide an electric lift mechanism comprising a platform, a lift actuator and the continuously variable speed controller as mentioned above. The lift actuator comprises a pushrod coupled to the platform and a motor configured to drive the lift actuator. The continuously variable speed controller is electrically connected to the motor and configured to adjust a moving speed of the pushrod continuously in lifting the platform.

Embodiments of the present disclosure further provide an electric massaging mechanism comprising a vibration motor and the continuously variable speed controller as mentioned above. The continuously variable speed controller is electrically connected to the vibration motor and configured to adjust at least one of a vibration intensity and a vibration frequency of the vibration motor.

With the above technical solutions, the present disclosure offers the following advantages:

1. The operation control unit is configured to detect an action variation quantity of the operating unit. As action variation quantities of the operating unit correspond to motor speeds, speed control becomes more intuitive. As the speed control is not restricted by limited gear positions, continuous speed variation is achieved. Further, due to elimination of a speed selector switch that would require matched control and detection ports, the product structure is simplified.

2. The pressure sensor and/or the angle sensor are provided, wherein the pressure sensor is configured to measure variation of the pressure against the stressed zone of the paddle, and the angle sensor is configured to measure variation of the pushed angle of the paddle. The information processor processes such variations to obtain the corresponding motor speed variation quantity. The motor speed variation quantity is transmitted to the motor controller, and then motor speed variation is realized by pushing the paddle. In this way, motor speed control is intuitive.

3. The pressure sensor is optionally a piezoelectric transducer, or a piezoresistive transducer, or a conductive elastic member, deformation of the conductive elastic member resulting in change to the current or resistance, thereby enabling determination of gear position.

4. Rotating of the first rotating housing results in change to the relative position between the magnetically inductive sensor and the magnet; the rotated angle of the first rotating housing is determined by detecting the number of pulse signals; and the motor speed variation quantity is determined based on the rotated angle. As such, a simplified structure is achieved, and an accurate measurement is enabled.

5. The rotated angle of the second rotating housing is determined by the rotating encoder or the angle sensor, and the motor speed variation quantity is determined based on the rotated angle.

6. Pressing the pushbutton results in deformation of the conductive elastic member disposed between the pushbutton and the circuit board; the resulting area or thickness variation of the conductive elastic member results in variation of resistance value. The variation of resistance value is detected and fed back by a corresponding circuit on the circuit board, based on which the motor speed variation quantity is determined.

7. Pressing the air chamber results in space change in the air chamber; the space change in turn causes air pressure change in the air chamber. The motor speed variation quantity is determined based on the air pressure change.

8. The present disclosure further provides an electric lift mechanism, comprising a platform, a lift actuator, and a continuously variable speed controller, wherein the continuously variable speed controller refers to the continuously variable speed controller in any of the technical solutions above, the continuously variable speed controller enabling control of the motor speed based on the action variation quantity of the operating unit to thereby adjust moving speed of the pushrod. As such, the electric lift mechanism enables speed adjustment by manipulating the operating unit. In this way, speed adjustment becomes more intuitive, and the structure of electric lift mechanism is simplified.

9. The present disclosure further provides an electric massaging mechanism, comprising: a vibration motor and a continuously variable speed controller, wherein the continuously variable speed controller refers to the continuously variable speed controller in any of the technical solutions above; the vibration motor refers to the motor in any of the technical solutions above. The continuously variable speed controller enables control of the vibration motor based on the action variation quantity of the operating unit and thereby adjustment of the vibration intensity or vibration frequency of the vibration motor. As such, vibration of the electric massaging mechanism becomes more intuitive, and the structure of the electric massaging mechanism is simplified.

### BRIEF DESCRIPTION OF THE ACCOMPANYING DRAWINGS

Hereinafter, the present disclosure will be further illustrated with reference to the accompanying drawings:

FIG. 1 is a structural schematic diagram of a continuously variable speed controller according to Embodiment 1 of the present disclosure.

FIG. 2 is a sectional view of the continuously variable speed controller according to Embodiment 1 of the present disclosure.

FIG. 3 is a local enlarged view of the continuously variable speed controller according to Embodiment 1 of the present disclosure.

FIG. 4 is a sectional view of a continuously variable speed controller according to Embodiment 2 of the present disclosure.

FIG. 5 is a structural schematic diagram of a continuously variable speed controller according to Embodiment 3 of the present disclosure.

FIG. 6 is a sectional view of the continuously variable speed controller according to Embodiment 3 of the present disclosure.

FIG. 7 is a sectional view of a continuously variable speed controller according to Embodiment 4 of the present disclosure.

FIG. 8 is a sectional view of a continuously variable speed controller according to Embodiment 5 of the present disclosure.

FIG. 9 is a local enlarged view of the continuously variable speed controller according to Embodiment 5 of the present disclosure.

### DETAILED DESCRIPTION OF THE PREFERRED EMBODIMENTS

Hereinafter, the present disclosure will be described in further detail through preferred embodiments with reference to the accompanying drawings. It needs to be understood that the orientational or positional relationships indicated by the terms “upper,” “lower,” “left,” “right,” “longitudinal,” “transverse,” “inner,” “outer,” “vertical,” “horizontal,” “top,” “bottom,” etc. are orientational and positional relationships only based on the drawings, which are intended only for facilitating or simplifying description of the present disclosure, not for indicating or implying that the devices/elements have to possess such specific orientations or have to be constructed and operated with such specific orientations; therefore, they should not be understood as limitations to the present disclosure.

### Embodiment 1

Embodiments of the present disclosure provide a continuously variable speed controller, comprising an operating unit and a control unit, the control unit comprising an information processor, an operation detector, and a motor controller; the input end of the operation detector is electrically connected to the operating unit, the output end of the operation detector is electrically connected to the information processor; the input end of the motor controller is electrically connected to the information processor, and the output end of the motor controller is electrically connected to the motor; the operation detector detects an action variation quantity of the operating unit and transmits the detection result to the information processor; the information processor obtains a corresponding motor speed variation quantity based on the detection result and transmits the obtained motor speed variation quantity to the motor controller; the motor controller changes the motor speed based on the motor speed variation quantity. In this way, speed control becomes more intuitive. As the speed control is not restricted by limited gear positions, continuous speed variation is achieved. Further, due to elimination of a speed selector switch that would require matched control and detection ports, the product structure is simplified.

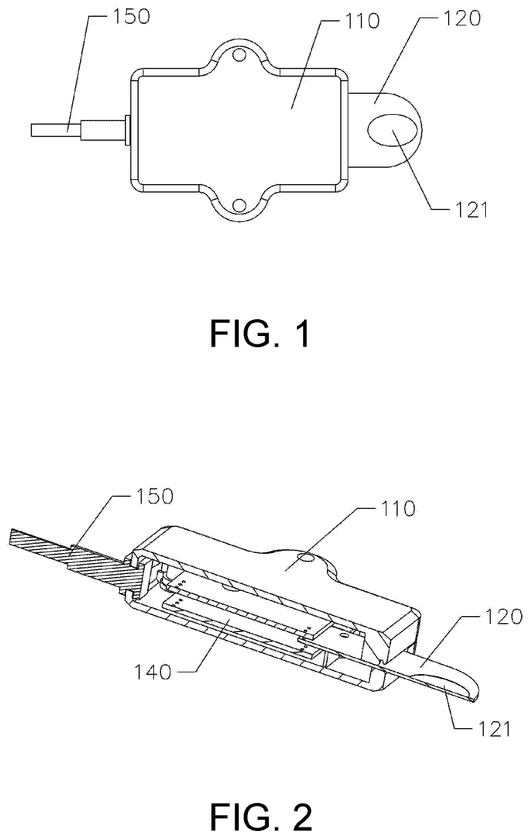

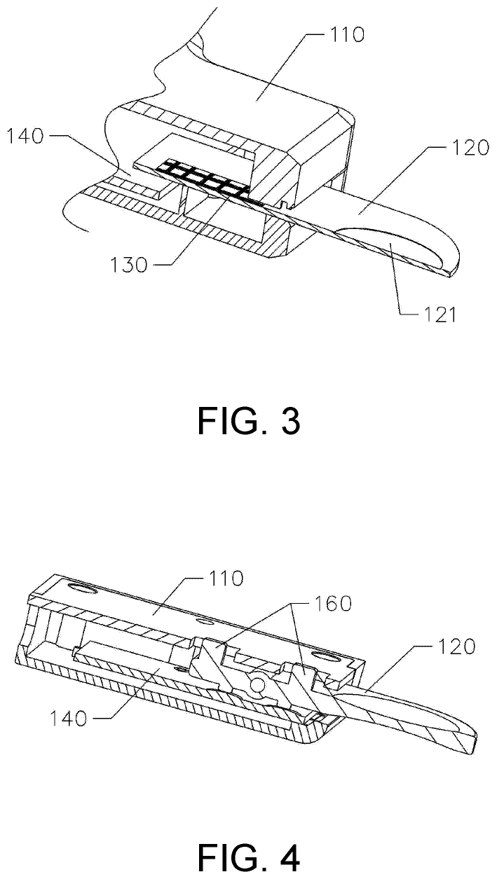

As shown in FIGS. 1-3, in this embodiment, the operating unit comprises a first shell 110 and a paddle 120 provided on the first shell 110; the paddle 120 is made of fiberglass fabric based copper-clad laminate that is robust, resilient, endurable for and recoverable from long-term bending; the operation detector comprises a pressure sensor, the pressure sensor being disposed in a stressed zone of the paddle 120. The stressed zone of the paddle is generally arranged at the position of fitting with the first shell or the position where the paddle is fixed. The pressure sensor measures pressure variation in the stressed zone of the paddle; the information processor obtains a corresponding motor speed variation quantity based on the pressure variation; motor speed variation is implemented by the motor controller based on the corresponding motor speed variation quantity; change of the motor speed is implemented by pushing the paddle 120. In this way, the motor speed is controlled in a more intuitive manner. The larger the force applied to push the paddle upward or downward, the higher the bend degree of the paddle, and correspondingly the higher rotary speed. The pressure sensor is optionally a piezoresistive transducer. In this embodiment, a full bridge strain gauge 130 is applied, which enables a better temperature compensation and an improved measurement accuracy. The full bridge strain gauge 130 is fixedly adhered to the paddle 120; when the paddle 120 is bent upwards or downwards, the full bridge strain gauge 130 is deformed to different extents to result in resistive value change; direction determination and signal amplification due to minor deformation are implemented by the subsequent circuit, and the motor speed variation quantity is obtained based on a preset correspondence between signal amplitude and speed.

The paddle 120 has a thickness of 1 mm; the fiberglass fabric based copper-clad laminate with a thickness of or under 1 mm has a good flexural hand feel and a good flexural deformation quantity and is quickly recoverable to the initial state.

The information processor and the motor controller are integrated onto the first signal processing board 140. The first signal processing board 140 is disposed in the shell and electrically connected to the pressure sensor. As such, the operating unit and the control unit of the continuously variable speed controller are integrated onto one component. The motor controller is connected to the motor via a wire 150 to thereby enable control of motor speed.

The control unit further comprises a safety detection module. In the case of failing to detect a safe release action, the safety detection module determines a careless operation, and the signal processor does not process the detected data, thereby preventing carelessness and offering a higher safety and reliability for using the continuously variable speed controller device.

In this embodiment, the safety detection module refers to a touch switch 121 on the paddle 120; when touch is detected by the touch switch to hold for a predetermined duration, the safety release action is actuated. In the case of failing to hold for a predetermined duration, the signal processor does not process the detected data, and the pushing action of the paddle is invalid. In this way, careless operation on the paddle is prevented, offering a higher safety and reliability for using the continuously variable speed controller. In an alternative embodiment, the touch switch 121 refers to a PCB touch pad.

Embodiments of the present disclosure further provides an electric lift mechanism, comprising a platform, a lift actuator, and a continuously variable speed controller, the lift actuator driving the platform to move up and down; wherein the continuously variable speed controller refers to the continuously variable speed controller in any of the technical solutions above; the lift actuator includes a motor and a pushrod; the motor refers to the motor in any of the technical solutions above; wherein the continuously variable speed controller enables control of the motor speed based on the action variation quantity of the operating unit to further adjust the telescoping speed of the pushrod. As such, the electric lift mechanism enables speed adjustment by manipulating the operating unit. In this way, speed adjustment becomes more intuitive, and the structure of the electric lift mechanism is simplified.

Embodiments of the present disclosure further provide an electric massaging mechanism, comprising: a vibration motor and a continuously variable speed controller, wherein the continuously variable speed controller refers to the continuously variable speed controller in any of the technical solutions above; the vibration motor refers to the motor in any of the technical solutions above; and the continuously variable speed controller controls rotary speed of the vibration motor to thereby change vibration intensity and vibration frequency of the vibration motor.

It will be appreciated that the paddle is alternatively a paper based copper-clad laminate or a metal based copper-clad laminate.

It will be appreciated that the operation detector is optionally an angle sensor such as an accelerometer or a gyroscope; the angle sensor is disposed on the follow-up surface of the paddle so as to sense the angle as the paddle is pulled upward or downward.

It will be appreciated that in an alternative embodiment, the operation detector simultaneously leverages a pressure sensor and an angle sensor, wherein the pressure sensor is provided in the stressed zone of the paddle, and the angle sensor is provided on the follow-up surface of the paddle.

It will be appreciated that the pressure sensor is optionally a piezoelectric transducer such as a piezoelectric thin film material, an annular or round piezoelectric plate.

It will be appreciated that the pressure sensor is optionally a piezoresistive transducer such as a single-bridge strain gauge or a half-bridge strain gauge.

It will be appreciated that the pressure sensor is optionally fixed to the paddle by embedding, fastening, suction, and bolt, etc.

It will be appreciated that the information processor and the motor controller are optionally separately provided, and the operation detector is electrically connected to the signal processor.

It will be appreciated that the safety detection module is optionally a pushbutton switch.

It will be appreciated that in an alternative embodiment, the continuously variable speed controller is configured to separately change the vibration intensity of the vibration motor by controlling the rotary speed of the vibration motor.

It will be appreciated that in an alternative embodiment, the continuously variable speed controller is configured to separately change the vibration frequency of the vibration motor by controlling the rotary speed of the vibration motor.

### Embodiment II

This embodiment differs from Embodiment I in that a different type of pressure sensor is used.

As shown in FIG. 4, the pressure sensor comprises a conductive elastic member 160, deformation of which results in resistance value change. By pushing the paddle 120, the conductive elastic member 160 is squeezed to deform. The larger the force applied to pull the paddle upward or downward, the greater the deformation of the conductive elastic member, and the higher the corresponding rotary speed. In an alternative embodiment, the conductive elastic member employs a conductive rubber.

It will be appreciated that in an alternative embodiment, the conductive elastic member employs a conductive sponge.

### Embodiment III

This embodiment differs from Embodiment I and Embodiment 2 in that the action variation quantity on the operating unit is an angle variation quantity.

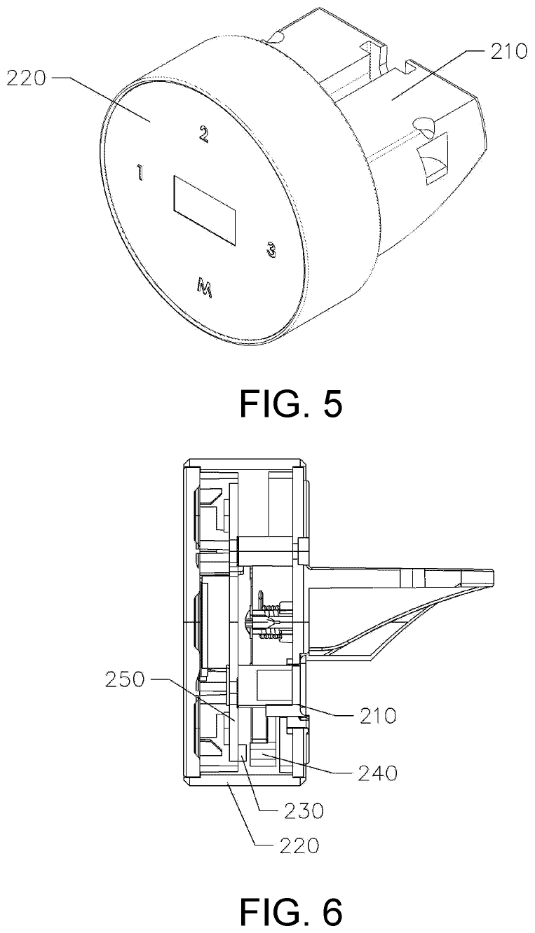

As shown in FIGS. 5 and 6, the operating unit comprises a second shell 210 and a first rotating housing 220 provided on the second shell 210; the operation detector comprises a magnetically inductive sensor and a magnet. In an alternative embodiment, the magnetically inductive sensor employs a Hall sensor 230; the Hall sensor 230 is provided on the first rotating housing 220 and is rotatable with the first rotating housing 220; the magnet employs a ring magnet 240; the ring magnet 240 is fixed in the second housing 210. Rotating of the first rotating housing 220 results in change to relative position between the Hall sensor 230 and the ring magnet. Rotated angle of the first rotating housing 220 is determined based on the number of pulse signals detected, and then the motor speed variation quantity is determined. As such, the structure is simplified, and an accurate measurement is achieved.

The information processor and the motor controller are integrated onto the second signal processing board 250, and the Hall sensor 230 is fixed on the second information processing board. It will be appreciated that in an alternative embodiment, the rotated angle of the first rotating housing is determined by detecting the output level amplitude of the Hall sensor.

It will be appreciated that the Hall sensor is securely fixed in the second shell, and the ring magnet is fixed onto the first rotating housing and is rotatable with the rotating housing.

It will be appreciated that in an alternative embodiment, the information processor and the motor controller are separately provided, and the operation detector is electrically connected to the signal processor.

It will be appreciated that in an alternative embodiment, the information processor and the motor controller are separately provided, and the operation detector and the signal processor are wireless connected.

### Embodiment IV

This embodiment differs from Embodiment III in that a different type of operation detector is used.

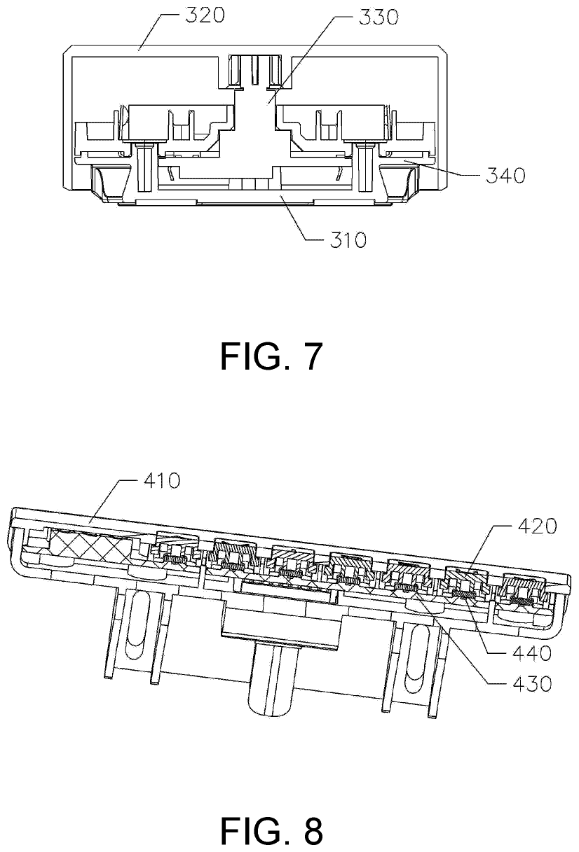

As shown in FIG. 7, the operating unit comprises a third shell 310 and a second rotating housing 320 provided on the third shell 310; the operation detector comprises a rotating encoder 330, wherein the rotating encoder 330 is fixed in the third shell 310. The rotating encoder 330 detects the rotated angle of the second rotating housing 320 by detecting the number of pulse signals and then determines the motor speed variation quantity.

The information processor and the motor controller are integrated onto the third signal processing board 340, and the rotating encoder 330 is also fixed on the third information processing board 340.

It will be appreciated that in an alternative embodiment, the operation detector refers to a rotated angle sensor, the rotated angle sensor being fixed on the second rotating housing.

It will be appreciated that in an alternative embodiment, the operation detector refers to a grating sensor; in this application scenario, the second rotating housing generally includes a bearing.

It will be appreciated that in an alternative embodiment, the information processor and the motor controller are separately provided, and the operation detector is electrically connected to the signal processor.

It will be appreciated that in an alternative embodiment, the information processor and the motor controller are separately provided, and the operation detector and the signal processor are wireless connected.

### Embodiment V

This embodiment differs from the previous embodiments in that the action variation quantity on the operating unit refers to a resistance variation quantity.

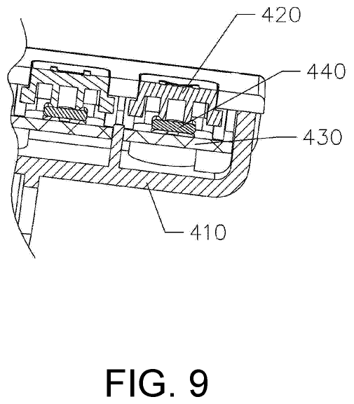

As shown in FIGS. 8 and 9, the operating unit comprises a fourth shell 410 and a pushbutton 420 provided on the fourth shell 410; the operation detector comprises a circuit board 430 that is provided in the fourth shell 410; a conductive elastic member is provided between the pushbutton 420 and the circuit board 430. Pressing the pushbutton 420 results in deformation of the conductive elastic member. The resulting area or thickness variation of the conductive elastic member results in variation of resistance value. The variation of resistance value is detected and fed back by a corresponding circuit on the circuit board 430, based on which the motor speed variation quantity is determined.

In this embodiment, the conductive elastic member refers to a conductive rubber 440; Pressing the pushbutton 420 results in deformation of the conductive rubber 440.

It will be appreciated that in an alternative embodiment, the conductive elastic member refers to a conductive sponge.

### Embodiment VI

This embodiment differs from the previous embodiments in that the action variation quantity of the operating unit is an air pressure variation quantity.

The operating unit comprises an air chamber. Space in the air chamber is compressible by pressing the air chamber, while compressed air chamber results in variation of the air pressure. The operation detector comprises an air pressure sensor that is provided in the air chamber. The motor speed variation quantity is determined based on the air pressure variation quantity detected in the air chamber. The air chamber is automatically recoverable to the initial position when it is not pressed.

### Embodiment VII

This embodiment differs from the previous embodiments in that the action variation quantity of the operating unit is a touch length.

The operating unit comprises a touch slide; the operation detector comprises a touch sensor; in an alternative embodiment, the motor speed variation quantity is determined based on slid length variation quantity detected of the touch slide.

It will be appreciated that in an alternative embodiment, the touch slide refers to a ring slip.

Besides the preferred embodiments above, the present disclosure also has other embodiments. Those skilled in the art may make various variations and alternations based on the present disclosure, and such variations and alterations should fall within the scope defined by the appended claims without departing from the spirit of the present disclosure.

What is claimed is:

1. A continuously variable speed controller, comprising:
an operating unit;
an operation detector, coupled to the operating unit to detect a continuous variation of an action of the operating unit;
an information processor, electrically connected to the operation detector, to obtain a corresponding motor speed variation quantity based on a detection result from the operation detector; and
a motor controller, electrically connected to the information processor, to receive the motor speed variation quantity and adjust a speed of the motor continuously based on the motor speed variation quantity.

2. The continuously variable speed controller according to claim 1, wherein the operating unit comprises a first shell and a paddle provided on the first shell; and the operation detector comprises at least one of a pressure sensor provided in a stressed zone of the paddle and an angle sensor provided on a follow-up surface of the paddle.

3. The continuously variable speed controller according to claim 2, wherein the pressure sensor comprises a piezoelectric transducer, a piezoresistive transducer, or a conductive elastic member, wherein deformation of the conductive elastic member results in a change to resistive value.

4. The continuously variable speed controller according to claim 2, wherein the information processor and the motor controller are integrated onto a first signal processing board, the first signal processing board being provided in the first shell and electrically connected to the pressure sensor.

5. The continuously variable speed controller according to claim 1, wherein the operating unit comprises a second shell and a first rotating housing provided on the second shell; the operation detector comprises a magnetically inductive sensor and a magnet, wherein the magnetically inductive sensor is provided on the first rotating housing and rotatable with the first rotating housing, and the magnet is fixed in the second shell.

6. The continuously variable speed controller according to claim 1, wherein the operating unit comprises a second shell and a first rotating housing provided on the second shell; the operation detector comprises a magnetically inductive sensor and a magnet, wherein the magnetically inductive sensor is fixed in the second shell, and the magnet is fixed on the first rotating housing and rotatable with the first rotating housing.

7. The continuously variable speed controller according to claim 1, wherein the operating unit comprises a third shell and a second rotating housing provided on the third shell, and the operation detector comprises a rotating encoder fixed in the third shell or an angle sensor fixed on the second rotating housing.

8. The continuously variable speed controller according to claim 1, wherein the operating unit comprises a fourth shell and a pushbutton provided on the fourth shell, and the operation detector comprises:
a circuit board provided in the fourth shell; and
a conductive elastic member provided between the pushbutton and the circuit board and configured to be deformed by pressing the pushbutton.

9. An electric lift mechanism, comprising:
a platform;
a lift actuator, comprising:
a pushrod coupled to the platform; and
a motor configured to drive the lift actuator; and
the continuously variable speed controller as claimed in claim 1, the continuously variable speed controller being electrically connected to the motor and configured to adjust a moving speed of the pushrod continuously in lifting the platform.

10. An electric massaging mechanism, comprising:
a vibration motor; and
the continuously variable speed controller as claimed in claim 1, the continuously variable speed controller being electrically connected to the vibration motor and configured to adjust at least one of a vibration intensity and a vibration frequency of the vibration motor.
